(19) United States
(12) Patent Application Publication
(10) Pub. No.: US 2006/0051151 A1
(43) Pub. Date: Mar. 9, 2006

(54) Printer

(75) Inventors: Jeroen J. G. Coenen, Venray (NL); Barry B. Goeree, Venlo (NL)

Correspondence Address: BIRCH STEWART KOLASCH & BIRCH, PO BOX 747, FALLS CHURCH, VA, 22040-0747, US

(73) Assignee: OCÉ-TECHNOLOGIES B.V.

(21) Appl. No.: 11/219,701

(22) Filed: Sep. 7, 2005

(30) Foreign Application Priority Data
Sep. 9, 2004 (NL) 1027003

(51) Int. Cl. B41J 15/04; B41J 15/00

(52) U.S. Cl. 400/613; 400/619

(57) ABSTRACT

A printing system for printing on a substrate which includes a holder, a roll containing a substrate wound thereon, said roll being rotatably held by the holder, a first transport means for engaging and transporting the substrate as it is unwound from the roll said transport means being disposed substantially parallel to the roll, a second transport means disposed downstream of the first transport means and substantially parallel to the roll, and a guide element disposed between the transport means and extending substantially parallel to the transport means, said guide element being constructed to feed the substrate at an angle of 0° and 180° from the first transport means to the second transport means, said guide element being at least partially rotatable about an axis substantially perpendicular to the direction in which the guide element extends, whereby the movement of the substrate at the guide element is allowed to extend in a direction substantially parallel to the direction in which the guide element extends.

### BACKGROUND OF THE INVENTION

The present invention relates to a printer, particularly an inkjet printer, which is equipped to print a substrate wound on a roll. In particular, in printers for substrates with wide formats, typically 0.5 to 1 meter wide, the substrate is frequently wound on a roll. A printer for printing this substrate frequently includes a holder for rotatably receiving the roll and means for winding the substrate off the roll and transporting it to a print engine for printing the substrate.

Since, during unwinding and transport, the substrate is always connected on one side (the start side) to the substrate wound on the roll, it is not immediately possible to bring this substrate into any desired position during transport. Also, in order to avoid mechanically loading the substrate excessively during transport, transport rollers are often very accurately constructed so that practically no forces are exerted on the substrate itself in a direction transverse to the direction of transport of the substrate. Forces of this kind may result in undesirable deformation of the substrate, such as creasing and tearing.

### SUMMARY OF THE INVENTION

The object of the present invention is to provide a printer with simple transport means to unwind the substrate from the roll and transport it further, during which transport the risk of undesirable deformation of the substrate is minimized. To this end a printer as defined in the claims of the present invention has been developed.

In the present printer, transport takes place with the use of two transport means which extend over substantially the width of the substrate and can therefore engage the substrate at places distributed over the width. Possible embodiments of such transport means may be continuous rollers, or even segmented means such as a shaft with a number of ribbed rollers, conveyor belts, conveyor balls, or other means for transporting flat substrates as known from the prior art. An important component of the printing system according to the present invention is the guide element which is situated between the transport means. The substrate is guided over this guide element, the substrate being bent off at an angle. The substrate is thus forced to deviate from the shortest route between the first and second transport means. A characteristic of the guide element is that it can at least partially rotate about an axis substantially perpendicular to the guide element. It has been found that in this way extra degrees of freedom are created for the transport of the substrate, and in conjunction with the other elements of the printer according to the present invention, this ensures that the objective of the invention can be achieved. To achieve this object, it has been found, for example, adequate for substantial parts to be rotatable around the ends of the elongate transport means in the manner described hereinbefore. In order to achieve the object of the present invention, it has also been found necessary for the guide element to allow a movement of the substrate parallel to the direction in which the element extends. A movement of this kind can, for example, be the pushing of the substrate over the guide element transverse to the direction of transport. This latter function and the other functions of the guide element can be obtained in many ways, for example by selecting specific combinations of materials for the element, a specific shape, a specific suspension, and so on.

In one embodiment, the axis extends substantially through the center of the guide element. It has been found that in this way the undesirable forces exerted on the substrate can be further reduced so that less accurate (mechanical) requirements have to be met for the transport means. This can lead to a further simplification of the printer and a corresponding reduction in cost.

In another embodiment, each of the transport means comprises at least one transport nip formed between two transport rollers. A transport nip of this kind is different from a transport means which, for example, engages in recesses in the substrate, suitable preferably for unwinding a flat substrate from a roll and transporting it further without the substrate having to experience damage, such as tearing.

In a further embodiment, the guide element is so disposed that the substrate at the place of contact with the guide element has a relative speed with respect to the guide element. In this embodiment, the substrate, in fact, slides over the guide element. This is particularly effective in order to allow free movement of the substrate in a direction parallel to the direction in which the guide element extends (transverse to the direction of transport of the substrate itself).

In still a further embodiment, the guide element is a substantially stationary plate. The plate can simply serve as the guide element by guiding the substrate over a surface of the plate. Since the plate is stationary, the substrate is in sliding contact with the plate and hence slides over the plate. Since the plate has, to some extent, low resistance to torsion, this is a very simple way of ensuring rotatability of at least part of the guide element about an axis substantially perpendicular to the guide element. A point of application for the plate in the center thereof is, for example, a way in which a rotational axis can be created around the center, at least for those parts of the plate which are situated in the surroundings of the two ends of the plate (these ends are in fact the furthest away from the center and can therefore move relatively easily with respect to the center of the plate).

In another embodiment, the plate has a bend which extends parallel to the direction in which the plate extends. As a result of this bend, it is possible to feed the paper at an angle with respect to the substrate, but approaching and leaving the guide element at an angle of zero degrees. The advantage of this is that fewer frictional forces occur between the substrate and the guide element so that the relative movement of the substrate with respect to the guide element is accompanied by fewer forces and accordingly there is a smaller risk of undesired mechanical wear of the substrate.

In yet another embodiment, a part of the plate situated upstream with respect to the bend is fixed to a rigid frame part of the printer. In this embodiment, the part of the plate where the substrate approaches and comes into contact with the plate is fixed on the frame part. This embodiment has been found to be advantageous because, particularly when the part of the plate where the substrate leaves the same has sufficient freedom of movement, it is a simple manner of providing the advantages offered by the present invention.

In still another embodiment, the plate is provided with slots. These slots have a number of advantages, the most important of which is that a greater possibility is created for the substrate to exchange heat and, particularly, moisture with the surroundings when the substrate is stationary with respect to the guide element. This takes place, for example, when the substrate is transported over a certain distance and a printing operation takes place on a downstream part of the now stationary substrate. A moderate exchange of heat and moisture can result in creases in the substrate. Such creases have a negative effect on the accuracy of the transport and can give rise to damages of the substrate.

In a further embodiment, the guide element is a roller. In this embodiment, guidance can be provided by allowing the roller to co-rotate with the substrate. As a result there is practically no friction, if any, between the guide element and the substrate, and this is an advantage in preventing damage to the substrate.

In one embodiment, the roller is fixed at its ends to the frame of the printer by spring elements. This resilient fixing mechanism can be used to ensure that the roller can rotate about an axis perpendicular to the direction in which the roller extends and also to allow movement of the substrate in a direction parallel to the longitudinal axis of the roller at the location of the roller. In one advantageous embodiment, these springs are leaf springs. For a stable and accurate guidance of the substrate, the springs are so disposed that they define the same angle of less than 90° with respect to the roller, in such a manner that the center lines of the leaf springs have a point of intersection upstream of the roller. This enables the roller to rotate about an axis through said (imaginary) point of intersection, and this enables movement of the substrate in a direction parallel to the roller.

In one specific embodiment of the printer according to the present invention, a third transport means situated further downstream for engaging and transporting the substrate is provided. A guide element is disposed between the first and second transport means and a guide element is disposed between the second and third nips.

### BRIEF DESCRIPTION OF THE DRAWINGS

The present invention will now be explained in detail with reference to the following drawings, wherein:

FIG. 1 is a diagram of a printer according to a specific embodiment of the present invention;

FIGS. 2a and 2b show a guide element that can be used as a guide for the substrate;

FIGS. 3a, 3b and 3c show another embodiment of the guide element; and

FIGS. 4a and 4b are diagrams showing the speeds at which the substrate is transported through the transport nips 32 (FIG. 4a) and 31 (FIG. 4b).

### DETAILED DESCRIPTION OF THE INVENTION

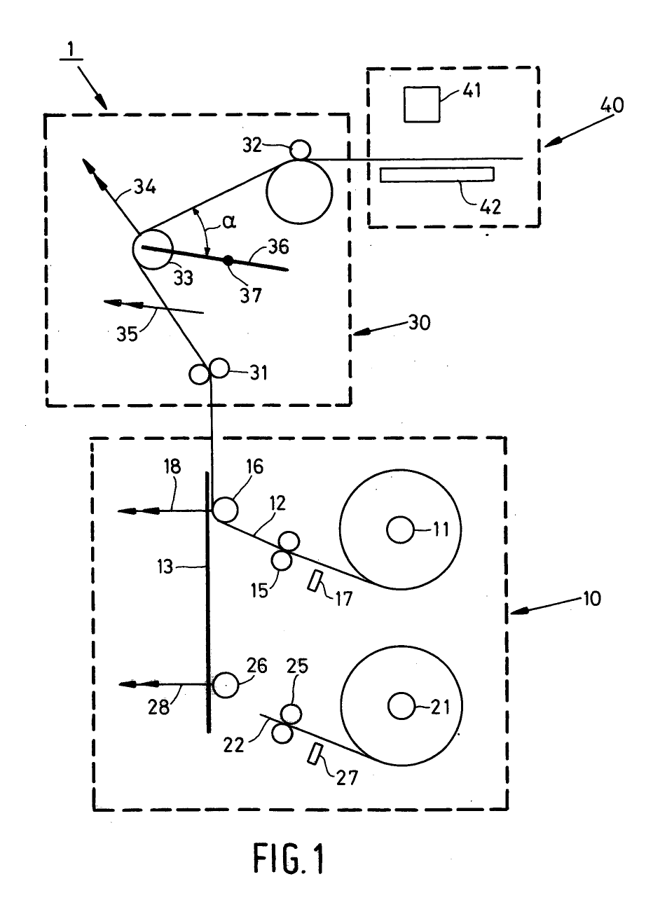

FIG. 1 is a diagram of a printer according to the present invention. This printer is provided with the supply unit 10, which serves for the storage and delivery of the substrate for printing. In addition, this printer includes a transport unit 30 which transports the substrate from the supply unit 10 to the print engine 40. Unit 30 also provides accurate positioning of the substrate in the print zone formed between the print surface 42 and the inkjet printhead 41. In this embodiment, print engine 40 is a conventional engine which includes printhead 41, which is constructed from a number of separate sub-heads, each with one of the colors: black, cyan, magenta and yellow. Printhead 41 has only a limited printing range so that it is necessary to print the image on the substrate in different sub-images. To this end, the substrate is transported in increments in each case so that a new part of the substrate can be printed in the print zone. In the example illustrated, the substrate 12 comes from a roll 11 from the supply unit 10. A web of the substrate is wound on this roll, the web having a length of 200 meters. To accommodate the roll in the printer, the supply unit is provided with a holder (not shown) to rotatably receive the roll. This holder consists of two parts mounted in side plates of the printer, which parts are brought into co-operative connection with the ends of the roll. In this embodiment, the supply unit is provided with a second holder to receive roll 21. Another substrate 22 is wound on this roll and can also be delivered by the supply unit for printing. For the transport of the substrate, roll 11 is operatively connected to transport means 15, which in this case includes a pair of rolls between which a transport nip is formed. More particularly, transport means 15 is a set of two shafts, each extending in a direction substantially parallel to roll 11, on which a number of roll pairs are mounted, each forming a transport nip for the substrate. In an alternative embodiment, only one roll pair is mounted on the shafts substantially coinciding with the middle of the web 12.

Upstream of means 15 is a sensor 17, by means of which it is possible to determine whether there is still substrate on the roll situated in the associated holder. As soon as the roll is used up, the end of the web will pass the sensor, and this is detected by the sensor. For the transport of a substrate originating from roll 21, the supply holder is provided with transport means 25. Upstream of the transport means the supply holder is provided with sensor 27, which has the same action as sensor 17. The supply holder is provided with guide elements 16 and 26 to guide the substrates 12 and 22, respectively, to the transport unit 30. Downstream of these guide elements, there is a transit path 13. This transit path is used for both the transport of substrate 12 and the transport of substrate 22.

A substrate leaving the supply unit 10, in this example substrate 12, is engaged by transport means 31 of the transport unit 30. This transport means transports the substrate via guide element 33 on to the second transport means 32 of the transport unit 30. The transport means 32 engages the substrate, transports it to print engine 40 and ensures good positioning of the substrate in the print zone between the print surface 42 and the printhead 41. The transport means 31 and 32 extend substantially parallel to the rolls 11 and 21, and have a length such that the substrate can be engaged over substantially its entire width.

The guide elements 16 and 26 are, in this example, rollers extending parallel to the transport means 15 and 31; 25 and 31 respectively. They are substantially stationary rollers, i.e., they do not rotate about their axial axis. For the substrate 12 illustrated, this means that during transport the substrate slides over element 16 and is at the same time fed in the direction of transport means 31. When this configuration is used it has been found that movement of the substrate at the guide element in a direction parallel to the direction in which the element extends is possible. In other words, the substrate can in this way make a lateral movement with respect to the direction in which the substrate is transported. The reason that a lateral movement of this kind is possible in this configuration is associated with the fact that the substrate makes a sliding movement with respect to the guide element. As a result, the required frictional force to set the substrate in motion initially with respect to the guide element is already overcome and practically no force is needed to move the substrate laterally over the guide element.

The guide elements are so disposed in the supply unit that they can each rotate, at least through a limited angle, about an axis substantially perpendicular to the direction in which the guide elements extend (i.e., the axial direction of the guide elements). In the Figure, the rotational axis 18 of element 16 is shown, and also rotational axis 28 of element 26. These rotational axes are perpendicular to the axes of the guide elements and intersect the center of said elements. As a result of this rotation combined with the possibility of moving the substrate laterally, the substrate has been found to have very good guidance from the supply unit 10 to nip 31 of the transport unit 30. As a result, despite the fact that the transport means 15 and 31; 25 and 31 respectively are not perfectly parallel, it is nevertheless possible to transport the substrate without any damage thereto.

Guide element 33 of transport unit 30, which element extends substantially parallel to the transport means 31 and 32, is also so disposed that it can rotate about an axis perpendicular to the axial direction of said element. This axis is shown by reference 34 and intersects the center of guide element 33. Since element 33, in this embodiment, is a co-rotating roller, the substrate is substantially stationary with respect to the surface of said guide element. As a result, lateral movement of the substrate at the guide element is made difficult. In order that such a movement can be made possible, element 33 is suspended so that it can rotate about axis 35, which axis 35 extends parallel to the bisector 36 of the angle 2α over which the substrate is fed from transport means 31 to transport means 32. This axis 35 intersects the center of the substrate web at a distance of about 1 meter from the guide element itself. On the rotation of element 33 about this axis, the substrate makes a substantially lateral movement. The possibility of rotation of guide element 33 over the axes of 34 and 35 ensures flexible and accurate transport of the substrate from transport means 31 to transport means 32, even though the two means do not extend 100% parallel to one another.

Guide element 33 is movable from a first position in which it is situated in FIG. 1, to a second position in which the center of this element coincides with the location 37. In the first position, the distance over which substrate 12 extends between transport means 31 and transport means 32 is at a maximum. In the second position this distance is at a minimum. Use is made of this fact during the transport of the substrate to print engine 40. Since the substrate must, in each case, be moved over a relatively short distance, typically 5 to 10 cm, it is advantageous for this to occur relatively quickly. The mass inertia of roll 11, certainly when it is provided with the maximum quantity of substrate, is relatively high. For this reason, if the configuration of transport means and guide elements as illustrated were maintained, movement would take a considerable amount of time. To counteract this problem, transport means 31 is accelerated much more slowly than transport means 32. Nevertheless, in order to ensure adequate supply of substrate to transport means 32, the guide element 33 is moved in the direction of location 37. As a result, there is no lack of substrate at transport means 32 during its passage to print engine 40. If the passage by transport means 32 is stopped, the residue at transport means 31 is compensated for by allowing the transport means to continue rotating for some time. In these conditions, the element 33 is moved back to its first position. In this way, prior to the subsequent transport of a part of the substrate requiring printing with print engine 40, guide element 33 is in the same initial starting position. It has been found that in this way very accurate transport of the substrate is possible. As a result, the various sub-images can match up more satisfactorily and the number of print artefacts can be reduced.

The provision of accurate transport and particularly accurate positioning of the substrate in the print zone by the control of transport means 32, is related to the fact that the substrate is engaged by both transport means 31 and transport means 32. The position of the substrate is more satisfactorily defined as a result. Together with the rotational possibilities of guide element 33, very accurate transport and positioning of the substrate is obtained with the tension in the substrate not increasing to the extent where, under normal circumstances, mechanical damage of the substrate would occur. An important additional advantage of this arrangement is that printing can still be continued on the substrate as long as the end of the web has not passed transport means 31. The instant at which this happens can easily be determined if the end of the web is detected by means of the sensor 17 or 27 operatively associated with the web. It is then a simple matter to determine what length of the substrate can still be fed on to the print engine 40 before the end of the web passes the means 31. In this way it is possible to determine whether the image printed at that instant can still be completely imaged on the substrate without the end of the web passing the first transport means. If so, that image will be completed. If not, then it is possible to choose to stop printing. However, when the end of the web passes means 31 the transport and the positioning of the substrate may be accompanied by more errors, and this may result in print artefacts. Too many artefacts can result in the image having to be reprinted. In order to save ink and substrate it is therefore better to stop printing.

If it is still possible to print the current image on the substrate (without the end of the web passing the means 31), it is then possible to determine whether the next image for printing can still be printed on the substrate (without the end of the web passing the means 31). If so, that image will be printed. If not, then it is better to print the following image on a new substrate, for example originating from roll 21.

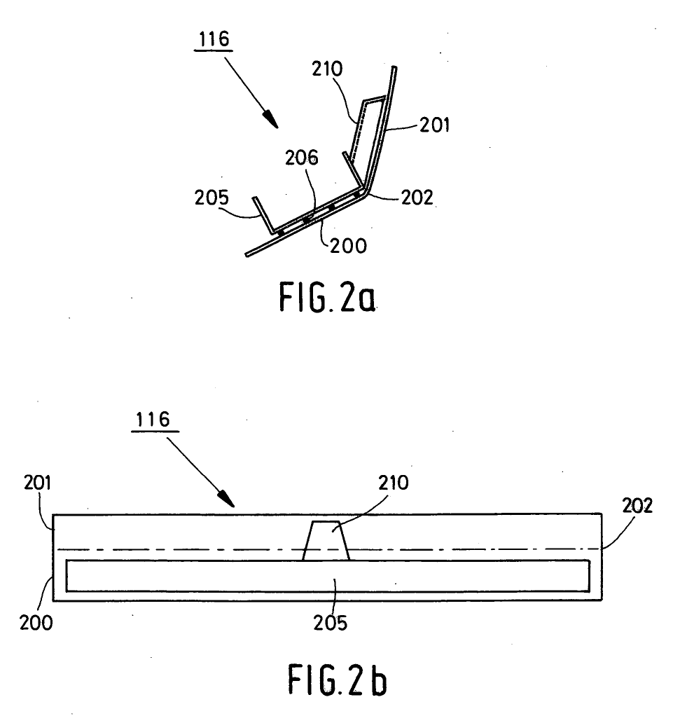

FIGS. 2a and 2b show a guide element 116 which can be used in a preferred embodiment as a guide for the substrate in the supply unit 10 (instead of the guide element 16 and/or 26). FIG. 2a is a side elevation of the guide element. This element comprises a bent plate having a part 200 situated upstream of the bend 202, and a part 201 which is situated downstream of the bend 202. Part 200 is connected by spot welds 206 to a rigid frame part 205. The frame part 205 has a U-shaped profile extending over the length of element 116 and connected to the frame of the printer. Part 201 of the plate is much less restricted in its freedom of movement than part 200. Yoke 210 fixed on the U-shaped profile 205 provides a point of support for part 201 as seen in the front elevation of element 116, as shown in FIG. 2b. It will be clear from this front elevation that part 201 is substantially free. Since the plate is relatively thin, part 201 is torsionally weak and can at least partially rotate about the axis passing through the center of the yoke 210 and perpendicular to the longitudinal axis of element 116. In one embodiment, part 201 is provided with slots so that this part has less resistance to torsion.

If element 116 is placed in the supply unit to replace element 16, the free end of plate part 200 points towards the transport nip 15 and part 201 is substantially parallel to the transit path 13 of the supply unit. Element 116 is also stationary in the supply unit. As a result of the tension in the substrate, part 201 can be pulled against yoke 210. As a result, the ends particularly of part 201 can rotate about the axis passing through the center of the yoke, perpendicular to the direction in which element 116 extends. The advantages of this rotational possibility are described under FIG. 1.

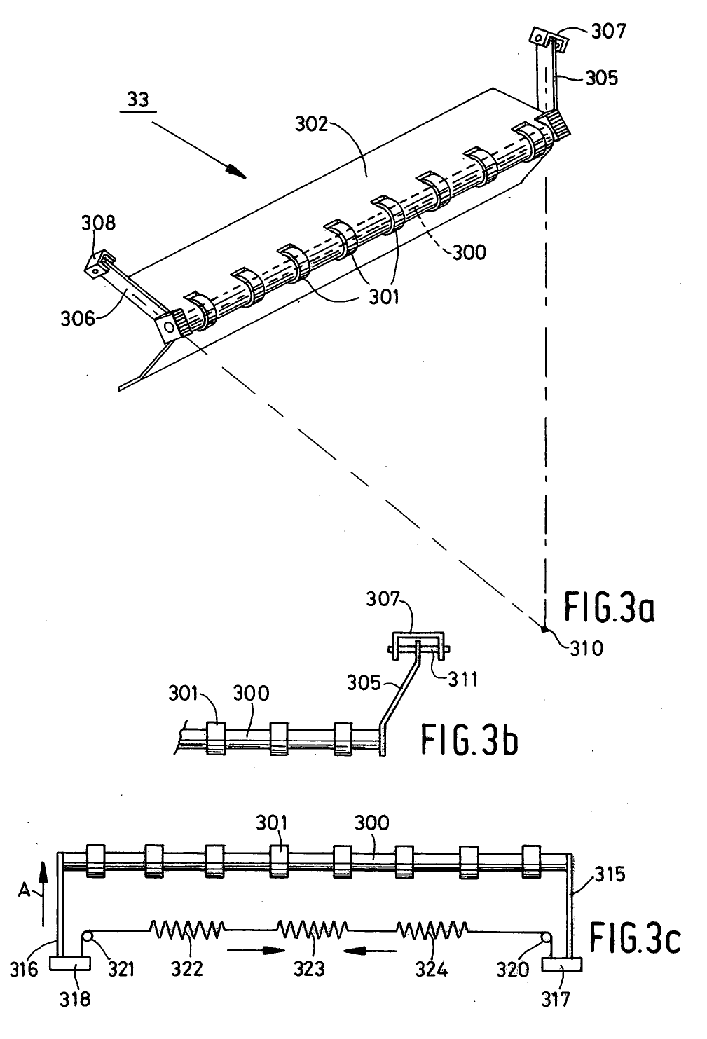

FIG. 3a is a diagram of one embodiment of guide element 33. In this embodiment element 33 comprises a shaft 300 on which a series of transport wheels 301 are disposed. The substrate is guided over these wheels. Since the shaft is suspended to be freely rotatable, it can co-rotate with the substrate without any mutual difference in speeds. As a result, the frictional force accompanying the transport of the substrate at the roller is practically only dependent on the friction in the mounting of this roller.

Element 33 is provided with a guide plate 302 bent in the form of a V to assist in guiding the substrate. It should also be clear that the V-shape of the element 302 substantially coincides with the V-shape of the substrate as shown in FIG. 1. Shaft 300 is resiliently suspended by leaf springs 305 and 306 which are fixed to be freely rotatable on fixed frame parts 307 and 308 respectively. These leaf springs each form the same angle with the shaft in such a manner that the center lines of the leaf springs have a point of intersection 310 upstream of the roller. Rotational axis 35 intersects this point of intersection.

FIG. 3b shows the suspension of the shaft in greater detail. The leaf spring 305 is fixed on the end of shaft 300. Leaf spring 305 is, in turn, fixed on shaft 311 which is suspended to be freely rotatable in U-shaped frame part 307. By means of this suspension it is possible for roller 33 to rotate about the axes 34 and 35. Although the rotational possibility is finite, it appears to be sufficient to make possible accurate and reliable transport of the substrate between the nips 31 and 32.

FIG. 3c diagrammatically shows the spring mechanism with which roller 33 is pushed in the indicated direction A. This direction A coincides with the direction extending from the above-mentioned second position that the element 33 can occupy (see FIG. 1, location 37) to the first position that the element occupies in FIG. 1. To this end, the shaft 300 is provided with side panels 315 and 316 which at their end remote from the shaft are provided with elements 317 and 318 respectively. The set of weak springs 322, 323 and 324 is fixed to these elements and freely guided over rotatable wheels 320 and 321. The springs are, to some extent, stretched so that they tend to move the ends of the set of springs to the center thereof, as indicated in FIG. 3c. As a result, the elements 317 and 318, and hence the shaft 300, are pushed in the indicated direction A.

Since the construction chosen results in a resistance to the displacement of the roller, a stiffness in respect of the movement of translation is introduced for the roller in principle. During movement of the roller to the second position, the resistance to this movement becomes increasingly greater. The advantage of this resistance is that the movement of the roller takes place more accurately and is more satisfactorily reproducible. By placing a number of long weak springs in series, this resistance remains sufficiently small but very effective.

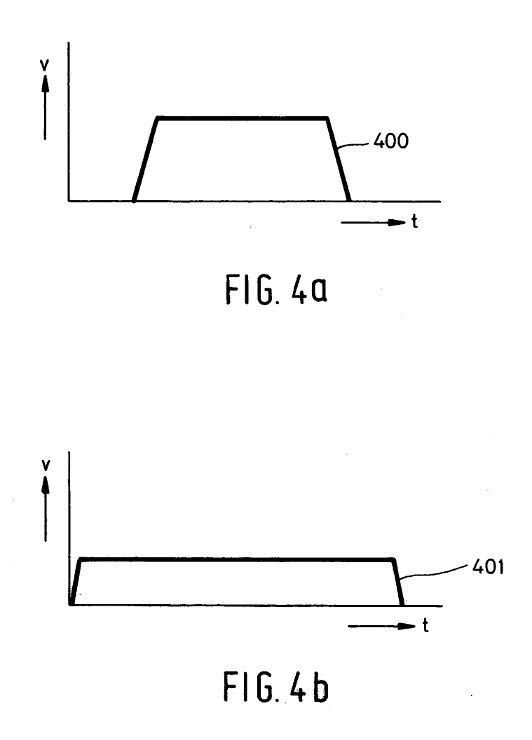

FIGS. 4a and 4b diagrammatically show the speed at which the substrate is transported through the transport nips 32 (FIG. 4a) and 31 (FIG. 4b) during the passage of part of the substrate so that a new strip thereof can be printed using the inkjet printhead 41.

Curve 400 in FIG. 4a shows what speed of passage is imposed on the substrate at the nip 32. A high speed of transit is generated relatively quickly and this is retained for some time and then rapidly drops to zero. Despite the high mass inertia of the roll on which the substrate is wound, this high acceleration can be obtained by moving roller 33 as indicated under FIG. 1.

Curve 401 in FIG. 4b shows the speed of transit imposed on the substrate at nip 31 for the transport of the same length of the substrate. It will be seen that this nip is driven before nip 32 so that the substrate is already partly unwound from roll 11 before nip 32 is driven. It may happen that movement of the roller 33 will enable the web to be tensioned between the means 31 and 32. The acceleration which is imparted by nip 31 is smaller than that of nip 32, and the maximum speed of transit that this nip provides is lower. However, the substrate is passed through for a longer time so that ultimately the same length of the substrate passes the nip 31.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A printer for printing on a substrate which comprises:
a holder,
a roll containing a substrate wound thereon, said roll being rotatably held by the holder,
a first transport means for engaging and transporting the substrate as it is unwound from the roll said transport means being disposed substantially parallel to the roll,
a second transport means disposed downstream of the first transport means and substantially parallel to the roll, and
a guide element disposed between the transport means and extending substantially parallel to the transport means, said guide element being constructed to feed the substrate at an angle of 0° and 180° from the first transport means to the second transport means, said guide element being at least partially rotatable about an axis substantially perpendicular to the direction in which the guide element extends, whereby the movement of the substrate at the guide element is allowed to extend in a direction substantially parallel to the direction in which the guide element extends.

2. The printer of claim 1, wherein the said axis passes substantially through the center of the guide element.

3. The printer of claim 1, wherein each of the transport means contains at least one transport nip formed between transport rollers.

4. The printer of claim 1, wherein the guide element is disposed such that the substrate has a relative speed with respect to said guide element at the place of contact with said guide element.

5. The printer of claim 4, wherein the guide element is a substantially stationary plate.

6. The printer of claim 5, wherein the plate has a bent configuration which extends substantially parallel to the direction in which said plate extends.

7. The printer of claim 6, wherein a part of the plate extending upstream with respect to a bend defining the bent configuration is fixed on a stiff frame part of the printing system.

8. The printer of claim 4, wherein the plate is provided with slots.

9. The printer of claim 1, wherein the guide element is a roller.

10. The printer of claim 9, wherein the roller is fixed to a frame of the printing system at its ends, by means of spring elements.

11. The printer according of claim 10, wherein the spring elements are leaf springs.

12. The printer of claim 11, wherein each of the leaf springs form the same angle of less than 90° with the roller so that the center lines of the leaf springs have a point of intersection upstream of the roller.

13. The printer of claim 1, wherein a third transport means is situated further downstream for engaging and transporting the substrate, wherein between the first and second transport means the guide element is a substantially stationary plate and between the second and third nips the guide element is a roller.

14. The printer of claim 1, said printer being an inkjet printer.

15. A guide element utilized to convey a substrate in a printer containing at least first and second transport means and disposed between said transport means, said guide element extending substantially parallel to the transport means and being constructed to feed the substrate at an angle of 0° and 180° from the first transport means to the second transport means, said guide element being at least partially rotatable about an axis substantially perpendicular to the direction in which the guide element extends, whereby the movement of the substrate at the guide element is allowed to extend in a direction substantially parallel to the direction in which the guide element extends.
